(19) United States
(12) Patent Application Publication
(10) Pub. No.: US 2002/0181238 A1
(43) Pub. Date: Dec. 5, 2002

(54) Folding lampshade

(76) Inventor: Chin-Feng Huang, Taipei (TW)

Correspondence Address: Jenifer C. Slinskey, Esq., Thorp Reed & Armstrong, LLP, One Oxford Centre, 14th Fl. 301 Grant St., Pittsburgh, PA, 15219-1425, US

(21) Appl. No.: 09/872,103

(22) Filed: Jun. 1, 2001

(51) Int. Cl. F21V 1/06

(52) U.S. Cl. 362/352; 362/356; 362/360

(57) ABSTRACT

A folding lampshade includes a lower wire frame, an upper wire frame, and a number of shade assemblies each having a number of flexible tabs adapted to be bent securely around the wire frames to connect the shade assemblies to the wire frames. Thus, the space taken by the folding lampshade may be reduced when necessary such as in storage or during transportation.

### BACKGROUND OF THE INVENTION

1. Field of the Invention

The present invention relates to a lampshade and, more particularly, to a folding lampshade in which the space it takes, such as in storage or during transportation may be reduced.

2. Description of Related Art

A lamp is generally provided with a lampshade to block direct light from the lamp from going in undesirable directions. For example, a floor lamp, as shown in FIG. 6, includes a base (50) supporting an upright post (51), and a lampshade (60) on top of the post (51).

The lampshade (60) here includes a rigid frame (61) shaped as a truncated pyramid, and a number of panels (63) held within the frame (61) on its four sides. Furthermore, an circular bracket (621) is centered on top of the frame (61) for the purpose of connection with the post (51).

It has been found, however, that a lampshade (60) of this rigid type really takes a much larger space than necessary both in storage and during transportation.

Therefore, it is an objective of the invention to provide a folding lampshade to mitigate and/or obviate the aforementioned problem.

### SUMMARY OF THE INVENTION

The object of the present invention is to provide a folding lampshade in which the space it takes can be reduced, such as in storage and during transportation.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of a folding lampshade in accordance with the present invention;

FIG. 2 is an exploded perspective view of the folding lampshade shown in FIG. 1;

FIG. 3 is a front view of the folding lampshade shown in FIG. 1;

FIG. 4 is an exploded perspective view showing the process of folding the lampshade of FIG. 1;

FIG. 5 is a perspective view showing the lampshade of FIG. 1 in a folded up position; and

FIG. 6 is a perspective view of a prior floor lamp.

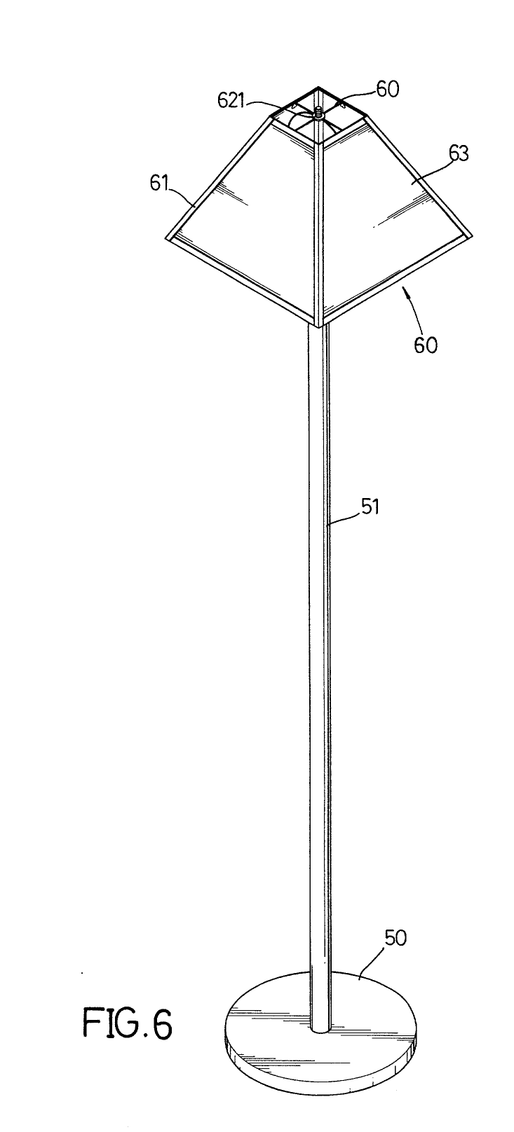

### DETAILED DESCRIPTION OF THE PREFERRED EMBODIMENT

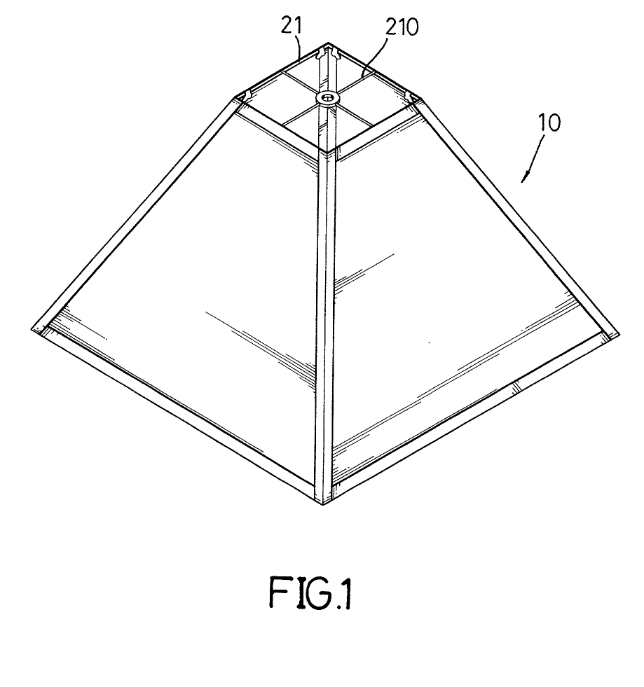

Referring to FIG. 1, there is shown a preferred embodiment of a folding lampshade (10), configured into a hollow truncated pyramid, in accordance with the present invention.

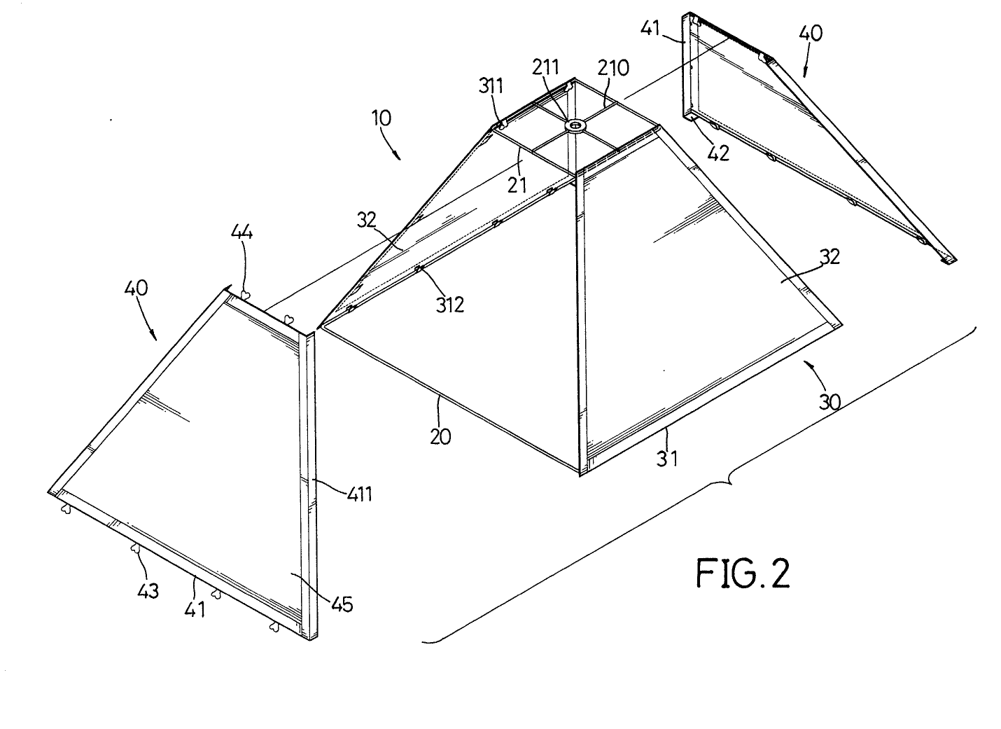

Referring to FIG. 2, the folding lampshade (10) includes a lower large wire frame (20) and an upper small wire frame (21). Both wire frames (20, 21) are thin and square, except that the upper wire frame (21) has a central annular bracket (211) supported by means such as by a number of wire supports (210).

There are two pairs of opposed shade assemblies (30, 40) arranged on the wire frames (20, 21) as the sides of the hollow, truncated pyramid. Each of the first shade assemblies (30) includes a first frame (31), a first shade (32) spreading within the first frame (31), and a number of flexible first tabs (311, 312) extending outward from the first frame (31) and adapted to be bent around the wire frames (20, 21).

Similarly, each of the second shade assemblies (40) includes a second frame (41), a second shade (45) spreading within the second frame (41), and a number of flexible second tabs (43, 44) extending outward from the second frame (41) and adapted to be bent around the wire frames (20, 21). The second frame (41) has a pair of angled stiles (411) to overlap the adjacent frames (31), and a pair of bottom stops (42) to contact the same adjacent frames (31).

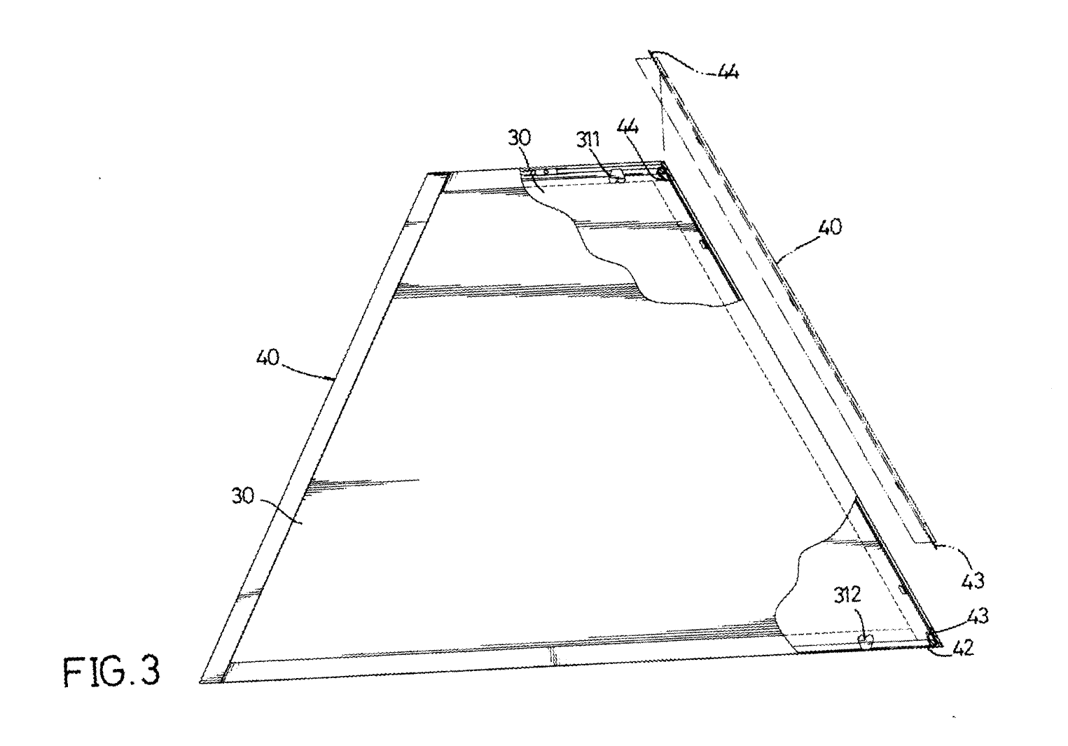

Referring to FIGS. 2 and 3, the folding lampshade (10) is assembled by connecting the first shade assemblies (30) to the wire frames (21, 20), by means of bending the first tabs (311, 312) securely around the wire frames (20, 21), which constructs the pyramid in an initial condition.

The second shade assemblies (40) are then arranged between the upper and lower wire frames (21, 20), with the angled stiles (411) overlapping and covering the adjacent first frames (41) and the bottom stops (42) covering the first frame bottom,thus aligning the frames. These shade assemblies (40) are connected to the upper and lower wire frames (20, 21) when the second tabs (43, 44) are bent securely around the upper and lower wire frames (20, 21).

It can be appreciated that the thinness of the wire frames (20, 21) allows the shade assemblies (30, 40) to be connected thereto and pivoted by means of the tabs (312, 43) bent around the bottom wire frame.

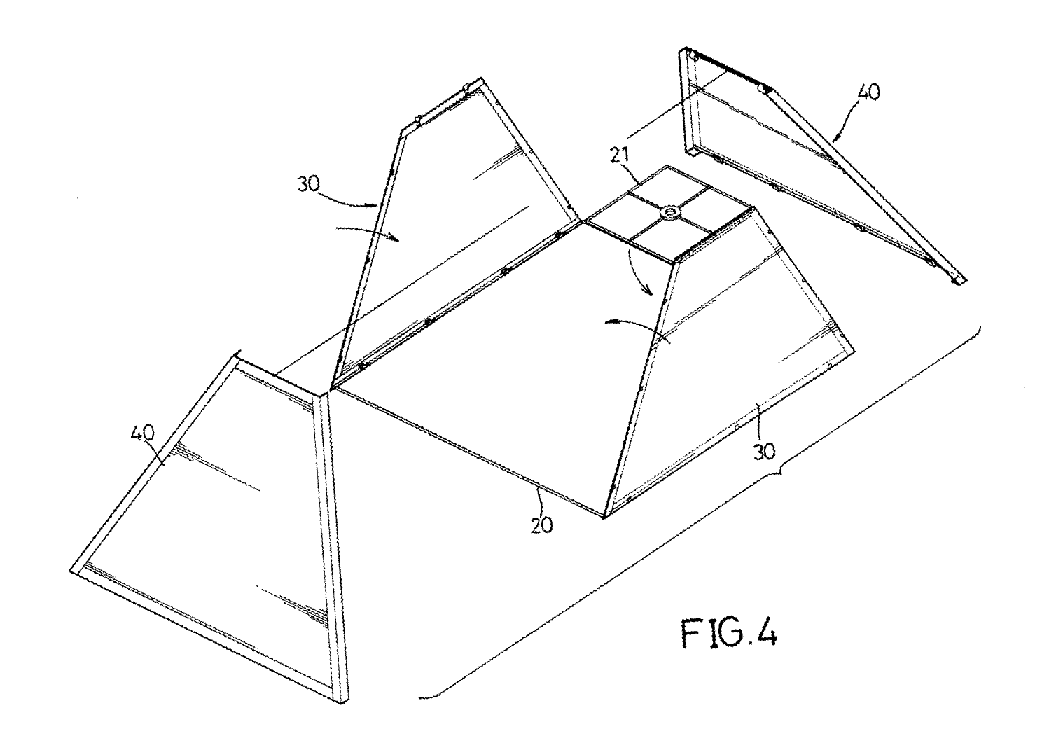

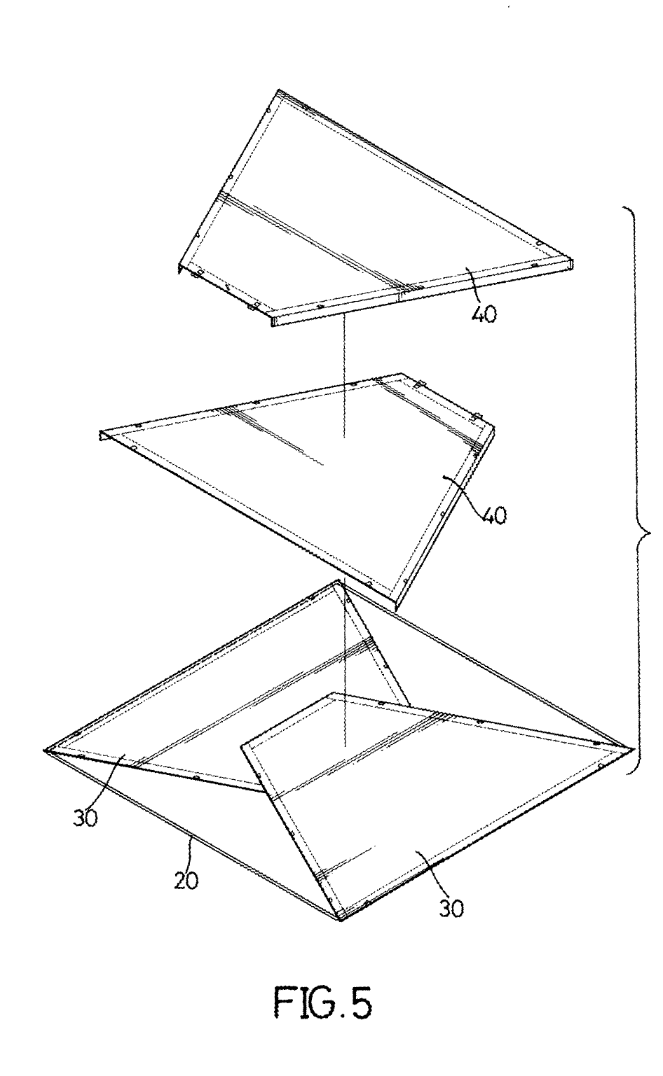

Referring to FIGS. 4 and 5, the inventive lampshade (10) can be folded up, such as for storage or transportation, simply by removing the second shade assemblies (40) from the remaining members as soon as the second tabs (43, 44) are released from the upper and lower wire frames (20, 21).

Once one of the first shade assemblies (30) is additionally disconnected from the upper wire frame (21), the upper wire frame (21) can be pivoted down and the first shade assemblies (30) can then also be pivoted down and folded over the lower wire frame (20), in directions as designated by respective arrows in FIG. 4, thereby folding up the lampshade (10) into a compact configuration as shown in FIG. 5.

From the above description, it is noted that the invention has the advantage of reducing the space it takes either in storage or during transportation.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A folding lampshade (10) comprising a lower wire frame (20), an upper wire frame (21), and a number of shade assemblies (30, 40) each having a number of flexible tabs (311, 312, 43, 44) adapted to be bent around said wire frames (20, 21) to connect said shade assemblies (30, 40) to said wire frames (21, 20).

2. The folding lampshade (10) as claimed in claim 1, wherein each of said wire frames (20, 21) is thin, thereby allowing said flexible tabs (311, 312, 43, 44) of said shade assemblies (30, 40) to be bent around the wire frames (20, 21).

3. The folding lampshade (10) as claimed in claim 2, wherein said upper wire frame (21) includes a number of wire supports (210) and a central annular bracket (211) connected by said wire supports (210).

4. The folding lampshade (10) as claimed in claim 3, wherein each of said shade assemblies (30, 40) includes a frame (31, 41) and a shade (32, 45) spreading within said frame (31, 41).

5. The folding lampshade (10) as claimed in claim 4, wherein one of an adjacent two of said frames (31, 41) has an angled stile (411) to overlap at least partially the other one of said adjacent two of said frames (31, 41).

6. The folding lampshade (10) as claimed in claim 5, wherein said angled stile (411) is formed with a bottom stop (42) to contact said other one of said adjacent two of said frames (31, 41), and to align the opposing frames with each other.
